(19) United States
(12) Patent Application Publication
(10) Pub. No.: US 2004/0146271 A1
(43) Pub. Date: Jul. 29, 2004

(54) Recording device, method, and system for recording a media transmission

(76) Inventor: David P. Burks, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/353,651

(22) Filed: Jan. 29, 2003

(51) Int. Cl. H04N 5/76; H04N 7/00

(52) U.S. Cl. 386/46; 386/83

(57) ABSTRACT

A method of recording a media transmission, comprising receiving, by a recording device, a media transmission comprising non-image data having scheduling parameters defining a media transmission schedule, receiving, by the recording device, a record signal, reading, by the recording device, the scheduling parameters, and recording, by the recording device, a media transmission scheduled for transmission in accordance with the scheduling parameters is provided.

### TECHNICAL FIELD OF THE INVENTION

This invention relates to consumer electronics and, more particularly, to a recording device, method, and system for recording a media transmission.

### BACKGROUND OF THE INVENTION

Since the introduction of the commercially-available video cassette recorder in 1969 and the video home system (VHS) standardization in the early 1970s, the video cassette recorder (VCR) has dominated the consumer electronics market and initiated popularity of home theater systems as well as given rise to the video rental industry. Originally developed in the mid-1950s to allow television broadcasts to be pre-recorded, the world-wide acceptance and utilization of the VCR has expanded dramatically.

However, a large portion of consumers do not program their VCRs to record television broadcasts for later viewing for a number of reasons. Some consumers find it difficult to program the VCR itself and are either unable or unwilling to learn the sequence of steps required to appropriately program a VCR to record a particular media broadcast in advance of the broadcast. Other consumers may have the ability to program the VCR but may lack the motivation to take the requisite time to do so in advance of a particular broadcast of interest. While most consumers, at times, may desire to pre-program a VCR to record an event in advance of the event transmission, these same consumers typically lack the initiative to obtain the event date and program the various information, such as the event date, day of week, broadcast time, broadcast end time, and channel of broadcast, into the VCR.

Often a consumer will realize that a particular event of interest desirable to have on video cassette has already been telecast. Other times a consumer will browse through various broadcasts to find a program of interest, that may be desirable to view in its entirety, already in progress.

### SUMMARY OF THE INVENTION

Heretofore, there have been no consumer electronic devices operable to facilitate recording of a telecast without consumer knowledge of a scheduled telecast and, accordingly, VCRs are often ineffectively utilized. In accordance with an embodiment of the present invention, a method of recording a media transmission, comprising receiving, by a recording device, a media transmission comprising non-image data having scheduling parameters defining a media transmission schedule, receiving, by the recording device, a record signal, reading, by the recording device, the scheduling parameters, and recording, by the recording device, a media transmission scheduled for transmission in accordance with the scheduling parameters is provided.

In accordance with another embodiment of the present invention, a recording device for recording a media transmission, comprising a receiver operable to receive a record signal, a clock maintaining a time, an input interface operable to receive a frame of a media transmission, and a processor operable to read and write data to a memory module, read scheduling parameters from a non-image field of the received frame, receive time from the clock, and actuate recording components of the recording device when a time defined by the scheduling parameters and the time provided by the clock coincide is provided.

In accordance with another embodiment of the present invention, a system for recording a media transmission, comprising means for receiving, by a recording device, a media transmission frame comprising non-image data having scheduling parameters defining a media transmission time, means for receiving, by the recording device, a record signal, means for storing, by the recording device, the scheduling parameters upon reception of the record signal, and means for recording, by the recording device, a media transmission scheduled for transmission in accordance with the scheduling parameters is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified diagram of a television broadcast frame formatted according to a National Television Standard Committee format;

FIG. 2A is a simplified diagram of an exemplary frame that may be utilized to carry programming information according to an embodiment of the present invention;

FIG. 2B is a simplified diagram of a line of a non-image field that may have programming information embedded therein according to an embodiment of the present invention;

FIG. 3 is a block diagram of components of a media recording system in which an embodiment of the present invention may be implemented; and

FIG. 4 is a more detailed block diagram of an embodiment of a recording device of FIG. 3.

### DETAILED DESCRIPTION OF THE DRAWINGS

The preferred embodiment of the present invention and its advantages are best understood by referring to FIGS. 1 through 4 of the drawings, like numerals being used for like and corresponding parts of the various drawings.

Most countries throughout the world utilize one of three well-accepted television broadcast standards: National Television Standards Committee (NTSC), Phase Alternating Line (PAL) and Sequential Couleur Avec Memoire (SECAM). Each standard defines various specifications of a television broadcast, for example the number of lines per field, horizontal frequency, vertical frequency, video bandwidth, audio carrier, etc. Each of the standards are generally incompatible with one another and, accordingly, terminal equipment such as a television set must have reception and conversion devices compatible with one of the three standards to properly receive and display a television broadcast. While each of the above-mentioned standards have distinguishable characteristics, they all operate according to common principles.

In general, a television has a screen having a phosphor coating thereon and which may be illuminated by passing an electron beam thereacross thereby ‘painting’ an image on the screen. Most television sets employ what is referred to as a ‘raster’ scan in which an image is displayed on the screen by a sequential composite of scan rows. Typical raster scans form an image by rapidly, for example 60 times per second, scanning rows from side to side and top to bottom across the screen surface.

Common television screens utilize an interlacing technique in which each image frame is divided into two fields respectively comprising half the viewable (or image) scan lines of the screen. The beam paints a frame by scanning every other line, for example all even numbered lines, as it moves down the screen. Scanning of the frame is then completed by scanning the remaining lines, for example all odd numbered lines, as it moves down the screen. Each even or odd set of scan lines may be referred to as a field. The process is repeated for sequential images. Progressive scanning may alternatively be utilized in which every line on the screen is sequentially scanned in each frame.

Each broadcast standard defines a number of scan lines and frame rate. For example, NTSC formatted broadcasts include 525 lines per frame broadcast at 30 frames (60 fields) per second. SECAM transmissions include 625 lines per frame broadcast at 25 frames per second. PAL transmissions include either 625 lines per frame broadcast at 25 frames per second or 525 lines per frame broadcast at 30 frames per second.

Generally, image (line) data is included within a composite video signal that includes control information as well as image data. Control information included within a composite video signal includes horizontal retrace signals that indicate when the beam is to be moved back to begin scanning a new line. Additionally, a vertical retrace signal is included within the composite signal to indicate when the beam is to be moved from the bottom of the screen to the top of the screen to begin painting a new frame. For example, a vertical retrace signal is included within the composite signal 60 times per second in an NTSC formatted broadcast.

With reference to FIG. 1, there is a simplified diagram of a television broadcast frame 100 formatted according to, for example, NTSC standards. Frame 100 includes horizontal lines, for example 525 lines 10A₁-10A₂₆₃ and 10B₁-10B₂₆₂ that are received and a portion of which are scanned on a television screen by directing an electron beam on a phosphor coated surface thereof. NTSC standards specify a vertical frequency of 60 Hz. Thus, each image line is painted 30 times per second due to interlacing lines 10A₁-10A₂₆₃ and lines 10B₁-10B₂₆₂. Lines 10A₁-10A₂₆₃ define a first field of frame 100 and lines 10B₁-10B₂₆₂ define a second field of frame 100. The television transmission may periodically include a horizontal retrace signal that indicates a return is to be made by the electron beam responsible for scanning the field on a television screen surface. For example, as an electron beam of a television performs a linear scan across the phosphor coated surface of a television screen thereby scanning line 10A₁, a horizontal retrace signal may be included within a composite signal that indicates an endpoint B of line 10A₁. Upon recognition of endpoint B, the electron beam performs a return, or horizontal retrace, and begins scanning line 10A₃ at point C. Scanning of each line 10A₁-10A₂₆₃ and 10B₁-10B₂₆₂ is similarly terminated by a respective horizontal retrace signal. Activation of the electron beam is temporarily suspended during each horizontal retrace to prevent a trail, or transient, on the screen. Each horizontal retrace is generally coded in the television broadcast with a distinctive waveform, such as a 5 microsecond pulse at zero volts that is recognizable by television set electronics that trigger the beam's retrace upon its recognition. Upon completion of a field, for example painting of lines 10A₁-10A₂₆₃, a vertical retrace is performed during which activation of the electron beam is temporarily suspended while the electron beam is repositioned to begin scanning of the next field, for example translation of the electron beam from point D terminating a final line 10A₂₆₃ of the first field to a start point E of a first line 10B₁, of a subsequent field, for example the field including lines 10B₁-10B₂₆₂. A vertical retrace may be coded within the television broadcast, for example by a 500 microsecond zero volt pulse. Conventional electronics within the television trigger the vertical retrace upon recognition of the vertical retrace signal. A vertical retrace is similarly utilized to begin scanning of a new frame upon completion of a final field of a previous frame.

The portion of a television transmission during which the electron gun is moved from the final line of one frame to the first line of a next frame is commonly referred to as a vertical blanking interval. The vertical blanking interval does not include image data as the activation of the electron gun must be suspended during the vertical retrace. The vertical blanking interval has been exploited to include non-image data, such as closed-captioning text included therein, to enhance a television broadcast. Inclusion of non-image information within the vertical blanking internal does not adversely affecting the quality of the television transmission itself because the vertical blanking interval is carried in the transmission between frames of image data that otherwise carry no information.

In an NTSC television transmission, for example, the vertical blanking interval comprises the first 21 lines of the 525 line transmission. In conventional transmissions, closed-captioning information may be embedded within the final line, that is in line 21, of the vertical blanking interval and is visible only when interpreted by a television equipped with a decoder. The present invention utilizes non-image field(s), such as the vertical blanking interval, to carry programming information that may be utilized to facilitate one-touch programming according to an embodiment of the present invention.

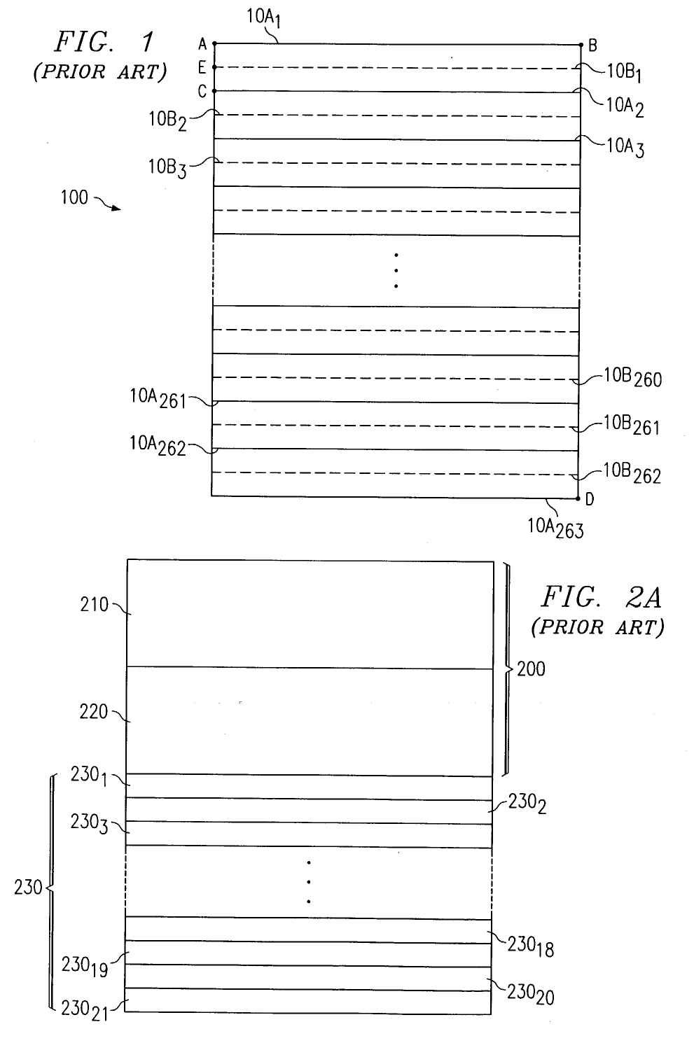

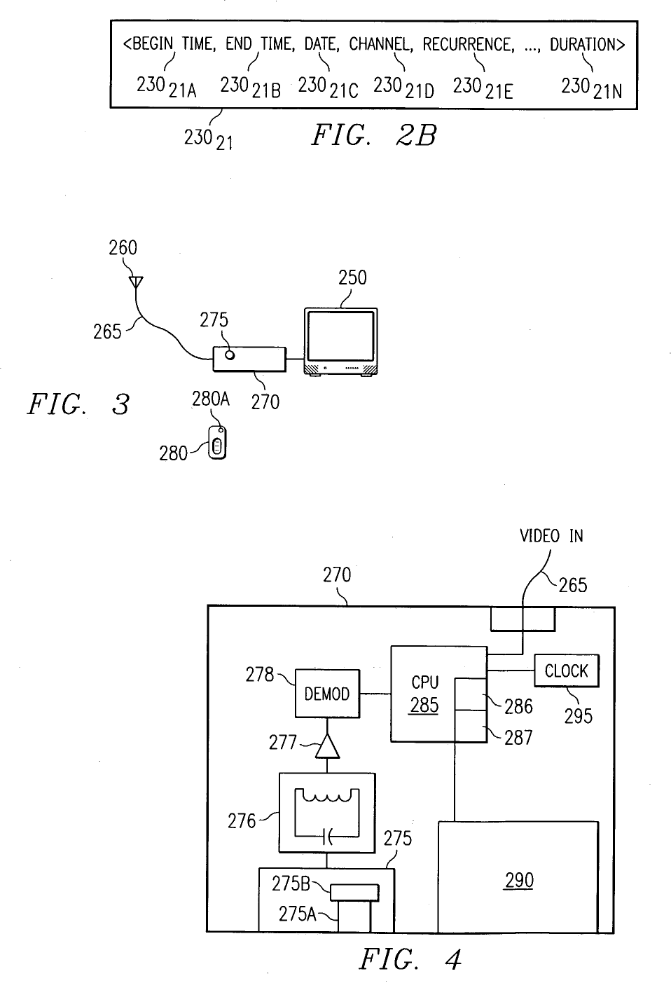

In FIG. 2A, there is a simplified illustration of an exemplary frame 200 that may be utilized to carry programming information according to an embodiment of the present invention. Frame 200 comprises two image fields 210 and 220 that may respectively comprise a plurality of lines of image data and a non-image field 230, such as a vertical blanking interval, that may comprise one or more lines 2301-23021 that may carry non-image data therein. Interlacing of image fields 210 and 220 is typically implemented to conjunctively comprise an image frame therefrom. Alternatively, frame 200 may comprise a single image field such that field 230 may be included within a progressive scanning transmission.

FIG. 2B, there is a simplified illustration of a line 230₂₁ of non-image field 230 that may have programming information embedded therein according to an embodiment of the present invention. Field 230 may have one or more scheduling parameters, such as parameters: begin time 230_{21A}, end time 230_{21B}, date 230_{21C}, channel 230_{21D}, recurrence 230_{21E} and a duration 230_{21N} embedded within line 230₂₁ thereof. It should be understood that each embedded scheduling parameter 230_{21A}-230_{21N} may be distributed over a line 230₂₁ of one or more frames 200 and/or a plurality of lines 230₁-230₂₁ of one or more frames 200. For example, in NTSC transmissions, the 21^{st} line of the vertical blanking interval may carry two characters of information. NTSC transmissions provide 30 frames (60 fields) per second during a transmission and, accordingly, up to 60 characters of information per second can be embedded within the 21^{st} line of the vertical blanking interval. Frame 200 may be formatted according to NTSC transmissions and each embedded scheduling parameters 230_{21A}-230_{21N} may be distributed over a plurality of lines 230₂₁ of a sequence of fields of transmitted frame(s). Embedded scheduling parameters 230_{21A}-230_{21N} may be periodically transmitted, for example once a minute, during a transmission.

FIG. 3, there is illustrated a simplified block diagram of components of a media recording system in a configuration according to an embodiment of the present invention. A recording device 270, such as a video cassette recorder, may have an antenna 260 coupled thereto via a conductive cable input 265 that interfaces therewith via an input port, such as a DIN connector, disposed thereon. Antenna 260 may be substituted with another device, such as a satellite dish or a cable descrambler box and cable medium input thereto, for receiving and providing media transmissions to recording device 270. Recording device 270 may be coupled to a television 250 via one or more conductive cables, such as component video cables, an S-video cable, a fiber optic cable, or another medium, connected to an appropriate jack at television 250 and recording device 270. Recording device 270 preferably includes a wireless input receiver 275, such as an infra-red receiver, operable to receive wireless commands transmitted from a remote control unit 280. Alternatively, remote control unit 280 may be tethered via a communication cable to recording device 270.

Recording device 270 receives sequences of frames 200 (FIG. 2A) via conductive cable input 265 and provides frames 200 to television 250 for display thereon. As shown in FIG. 4, recording device 270 includes an input receiver 275, such as an infra-red receiver, that may include an optical filter 275A and one or more signal detectors 275B, such as photodiodes, connected thereto. Optical filter 275 may operate to filter a remote signal from ambient noise such as light impinging on receiver 275 generated from fluorescent lights or other ambient light sources. Remote signals passed to signal detectors 275B may then be supplied to a filter 276 and tuned to a carrier frequency of remote control unit 280 in the event remote control unit 280 modulates remote control commands emitted therefrom. Signals passed by filter 276 may then be supplied to an amplifier 277 and fed to a demodulator 278 that outputs binary sequences representative of control commands emitted from remote control unit 280. A microprocessor 285, such as an INTEL 8051 microcontroller or other suitable processor, included within recording device 270, may receive demodulated signals and direct operation of recording device 270, television 250, and/or another peripheral device connected thereto in response to interpretation of the decoded signal(s). Microprocessor 285 may include one or more memory modules 286, such as random access memory (RAM) and/or a programmable read-only memory (PROM). Alternatively, or in addition to memory modules 286, recording device 270 may include memory banks external to and interconnected with microprocessor 285.

Frames 200, or fields 230 thereof, received by recording device 270 via input cable 265 may be passed to microcontroller 285 and one or more lines of non-image data may be analyzed for embedded parameters having scheduling information carried therein. The contents of one or more scheduling parameters 230_{21A}-230_{21N} read by microprocessor 285 may be recorded in memory module 286. As embedded scheduling parameters 230_{21A}-230_{21N} are re-encountered during a transmission, microprocessor 285 may update the contents thereof that are maintained in memory module 286 to facilitate maintenance of current programming information.

Remote control device 280 may include a key 280A designated as a record key and emit a record signal upon depression of key 280A. Upon reception of the record signal by receiver 275 and processing thereof by various circuitry of recording device 270, the record signal is interpreted by microprocessor 285. Microprocessor 285 may then interrogate memory module 286 for the contents of the most recently received scheduling parameters 230_{21A}-230_{21N} (FIG. 2B) of the transmission received via input cable 265. A recording algorithm 287 may be retrieved, for example from memory module 286, and executed by microprocessor 285. Recording algorithm 287 may receive contents of one or more scheduling parameters 230_{21A}-230_{21N} stored in memory module 286 as input thereto. One or more recording circuitries and/or recording device components 290 may be actuated upon command of microprocessor 285 in response to execution of recording algorithm 287.

Recording algorithm 287 facilitates execution of one-touch media recording in conjunction with various scheduling parameters 230_{21A}-230_{21N} carried in non-image field 230 of transmission frame(s) 200. A user may depress key 280A at any point during a television transmission and a record signal is transmitted from remote control unit 280 to recording device 270. Upon interpretation of the received record signal, recording device 270 retrieves the contents of one or more scheduling parameters 230_{21A}-230_{21N} stored in memory module 286. The contents of scheduling parameters 230_{21A}-230_{21N}, or a portion thereof, are supplied to recording algorithm 287. Recording algorithm 287 may then set one or more recording directives that may be stored in memory module 286. Recording directives stored in memory module 286 may specify a start time, end time, duration, and/or channel that collectively coincide with a television transmission as defined by scheduling parameters 230_{21A}-230_{21N}.

A user, while watching a television transmission, may desire to record the media program currently being viewed. Often a user will browse through various channels and find a media program of interest that is already in progress. The user may desire to have the media program recorded in its entirety. The present invention allows the user to have the media program recorded in its entirety during its next transmission by simply pressing key 280A while the media program is in transmission. The user does not have to have knowledge of the next scheduled transmission but only has to indicate the desire to have the transmission recorded by depression of key 280A. Upon reception of the code assigned to key 280A by recording device 270, contents of scheduling parameters 230_{21A}-230_{21N} may be retrieved by recording algorithm 287 and a recording period is set thereby. Scheduling parameters 230_{21A}-230_{21N} may include a recurrence parameter 230_{21E} that specifies a period of recurrence for the particular television transmission. For example, the television transmission may be a television program telecast once a week. An indicator within the recurrence parameter 230_{21E} may specify the recurrence such that recording algorithm 287 may determine the next transmission of the subject television program. Other parameters, such as date parameter 230_{21C} may include a date of one or more subsequent telecasts of the television program. A begin time parameter 230_{21A} and an end time parameter 230_{21B} may respectively include data indicative of a start time and end time of one or more future telecasts. A channel parameter 230_{21D} indicates the channel on which the future media transmission is to be recorded. While the scheduling parameters are described as defining future transmissions of a television series, the present invention is not limited to such media transmissions. For example, a movie broadcast on cable television is often repeatedly transmitted multiple times in a day, week, or another time period. Scheduling parameters 230_{21A}-230_{21N} may be embedded within frames of a movie transmission and define a subsequent transmission of the movie. A user browsing through television channels and finding a movie transmission in progress in accordance with the present invention needs only actuate key 280A for a future transmission of the movie to be recorded. Moreover, the present invention may advantageously facilitate one-touch recording of an advertised media feature. For example, a commercial advertising an upcoming media transmission, such as a movie, a television program or series, a sporting event, or another media transmission, having scheduling parameters 230_{21A}-230_{21N} defining the advertised media transmission schedule embedded within one or more fields of the transmitted advertisement allows the user to program the recording device to record the upcoming media transmission by actuating record key 280A.

In general, contents of a non-image field, such as scheduling parameters of line 230₂₁ of non-image field 230, include data sufficient to define a transmission schedule of a future media transmission. Recording device 270 is operable to read scheduling parameters 230_{21A}-230_{21N} and store parameters indicative of a future telecast in memory module 286. Recording algorithm 287 may periodically poll contents of memory module 286 and perform comparisons with current date and time information obtained from system clock 295. Processor 285 may then activate recording circuitries and/or recording device components. 290 upon determination that a current time obtained from clock 295 corresponds with a scheduled telecast as defined by scheduling parameters read from a field of a transmission frame and maintained in memory module 286.

In another embodiment, frame 200 may be included within a sequence of frames of a television advertisement to facilitate one-touch recording of an advertised telecast. For example, a transmitting station may provide an advertisement for an upcoming telecast and include non-image data within field 230 having scheduling parameters that may be read and stored by recording device 270. Upon issue of a record command by depression of key 280A, the contents of non-image field 230 may be read and conveyed in memory module 286. Processor 285 actuates recording circuitries and/or recording device components 290 upon determining a match between the media transmission schedule as determined by a comparison of the stored scheduling parameters previously read from the advertisement transmission and clock 295.

Clock 295 preferably provides a standardized time format universal across time zones. For example, clock 295 may provide Greenwich mean time (GMT) such that recording device 270 is compatible in multiple time zones. Accordingly, schedule parameters, such as a begin time and end time, respectively included within begin time parameter 230_{21A} and end time parameter 230_{21B}, are preferably provided in GMT format.

Due to the number and various sources of media transmissions, a consumer operating the recording device of the present invention is likely to periodically receive a telecast that does not include the non-image data for recording a subsequent transmission of the telecast according to the techniques as described herein. Thus, it may be advantageous for a telecast having the non-image programming data to also have viewable image data indicative of the inclusion of the non-image media scheduling data. For example, one or more frames of a telecast having scheduling parameters within one or more lines of a non-image field may advantageously have a visual indicator included with one or more image fields of the frame(s). The visual indicator may be superimposed over other image data carried in image field(s) of one or more telecast frames and may comprise a text indicator, a symbolic indicator, or another visual item. Rather than having the visual indicator superimposed with image data of frame(s) of a telecast, the recording device may alternatively be operable to superimpose a visual indicator on images output thereby. That is, the recording device may be operable to, upon recognition of the inclusion of non-image media scheduling data within a received telecast, superimpose a visual indicator on an image portion of one or more frames to denote that the particular telecast being viewed may be recorded according to the one-touch recording techniques described herein.

While the present invention has been described in accordance with frames formatted according to a standardized television telecast format similar to NTSC, it should be understood that the particular format of frame 200 is illustrative only, is described herein to facilitate an understanding of the invention, and may be formatted in accordance with NTSC, PAL, SECAM, or another suitable transmission format including both analog and digital protocols. Additionally, the invention may be applied to any one of numerous image transmission technologies, such as satellite transmission, cable television transmission, Internet streaming technologies, and other media delivery systems, without departing from the spirit and scope of the invention.

What is claimed is:

1. A method of recording a media transmission, comprising:
receiving, by a recording device, a media transmission comprising non-image data having scheduling parameters defining a media transmission schedule;
receiving, by the recording device, a record signal;
reading, by the recording device, the scheduling parameters; and
recording, by the recording device, a media transmission scheduled for transmission in accordance with the scheduling parameters.

2. The method according to claim 1, further comprising receiving the record signal from a remote control unit, the remote control unit transmitting the record signal to the recording device upon actuation of a key.

3. The method according to claim 1, further comprising storing, by the recording device, the scheduling parameters.

4. The method according to claim 1, wherein receiving a media transmission further comprises receiving a plurality of media frames each respectively comprising non-image data, the scheduling parameters distributed over the plurality of frames.

5. The method according to claim 1, wherein receiving a media transmission further comprises receiving a media frame formatted according to a format selected from the group consisting of a National Television Standards Committee format, Phase Alternating Line format and Sequential Couleur Avec Memoire format.

6. The method according to claim 1, wherein recording the media transmission further comprises polling a clock, recording the media transmission occurring when a transmission time defined by the scheduling parameters and a time provided by the clock coincide.

7. The method according to claim 6, wherein polling a clock further comprises polling the clock for a time formatted according to Greenwich Mean Time.

8. The method according to claim 1, wherein receiving a media transmission comprising non-image data further comprises receiving a frame comprising at least one of a start time, an end time, a date, and a transmission channel.

9. The method according to claim 1, wherein receiving a media transmission further comprises receiving a media frame of a cable television transmission.

10. The method according to claim 1, wherein receiving a media transmission further comprises receiving a media frame comprising an Internet media transmission.

11. The method according to claim 1, wherein receiving a media transmission further comprises receiving a media frame comprising a satellite television transmission.

12. A recording device for recording a media transmission, comprising:
a receiver operable to receive a record signal;
a clock maintaining a time;
an input interface operable to receive a frame of a media transmission; and
a processor operable to read and write data to a memory module, read scheduling parameters from a non-image field of the received frame, receive time from the clock, and actuate recording components of the recording device when a time defined by the scheduling parameters and the time provided by the clock coincide.

13. The recording device according to claim 12, wherein the time maintained by the clock is maintained according to a Greenwich Mean Time format.

14. The recording device according to claim 12, wherein the processor writes the scheduling parameters into the memory module upon reception of the record signal.

15. The recording device according to claim 12, wherein the input interface is operable to receive a frame formatted according to at least one of National Television Standards Committee, Phase Alternating Line and Sequential Couleur Avec Memoire format.

16. The recording device according to claim 12, wherein the input interface is operable to receive a frame transmitted from at least one of a satellite transmission and a cable television transmission.

17. A system for recording a media transmission, comprising:
means for receiving, by a recording device, a media transmission frame comprising non-image data having scheduling parameters defining a media transmission time;
means for receiving, by the recording device, a record signal;
means for storing, by the recording device, the scheduling parameters upon reception of the record signal; and
means for recording, by the recording device, a media transmission scheduled for transmission in accordance with the scheduling parameters.

18. The system according to claim 17, wherein means for receiving a media transmission frame comprising non-image data further comprises means for receiving a plurality of frames each respectively comprising non-image data, the scheduling parameters distributed over the plurality of frames.

19. The system according to claim 17, wherein means for recording the media transmission further comprises means for polling a clock, recording of the media transmission occurring when a transmission time defined by the scheduling parameters and a time provided by the clock coincide.

20. The system according to claim 17, wherein means for receiving a media transmission frame comprising non-image data further comprises means for receiving at least one of a start time, an end time, a date, and a transmission channel.
